(19) United States
(12) Patent Application Publication
(10) Pub. No.: US 2008/0081672 A1
(43) Pub. Date: Apr. 3, 2008

(54) Mobile communication terminal apparatus

(75) Inventor: Izuru Miyamoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/809,278

(22) Filed: May 31, 2007

(30) Foreign Application Priority Data
Sep. 29, 2006 (JP) P2006-269784

(51) Int. Cl. H04M 1/00

(52) U.S. Cl. 455/566; 455/550.1

(57) ABSTRACT

According to an embodiment of the invention, there is provided a mobile communication terminal apparatus including: a communication unit configured to perform a predetermined communication; a storage unit configured to store a first state of an application program before being initialized and a second state of the application program after being initialized; an application management unit configured to activate based on the second state of the application program stored in the storage unit in preference to the first state of the application program stored in the storage unit. The application management unit causes the storage unit to store the second state of the application program if the communication unit performs the predetermined communication.

### CROSS-REFERENCE TO RELATED APPLICATIONS

This application is based on and claims the benefit of priority from the prior Japanese Patent Application No. 2006-269784, filed on Sep. 29, 2006; the entire contents of which are incorporated herein by reference.

### TECHNICAL FIELD

The present invention relates to a mobile communication terminal apparatus and, in particular, to a high-speed processing for activating an application program.

### BACKGROUND

### Description of Related Art

Mobile communication terminal apparatuses not only have a communication function, but also an application function implemented by an application program. However, due to strict limits on their power consumption and size of the apparatus, mobile communication terminal apparatuses are required to operate at a high speed with a CPU having limited performance and a storage section having a limited storage capacity. Thus, the initialization time of an application program should be shortened.

Here, the initialization of an application program is, when the application program is written in a procedural language, an operation for assigning a value into a variable, which ends in a relatively short time. However, when the program is written in an interpreter language, the initialization is an operation such as executing a static function, which requires a long time.

Particularly, when the program is written in an object-oriented language such as JAVA®, an exceptionally a long time is required for the initialization due to object creation using a static function.

It is disclosed, by for example JP-A-10-293682, that, to avoid requiring a long time for activation of an application program, for example, information placed in main storage in an initialized state of the application program including an OS is stored and then used without modification, so that the application program including an OS can be activated in a short time.

In the method disclosed in JP-A-10-293682, however, an OS and an application program are integrally used. Thus, even for an application program that is not necessarily to be activated in a short time, information to be placed in main storage is stored in an initialized state. This has caused a difficulty in storing information in an initialized state in a storage section having a limited storage capacity.

Further, when adding, deleting, or updating an application, the initialization requires a long time to newly generate information in an initialized state of an application program including an OS.

### SUMMARY

According to an embodiment of the invention, there is provided a mobile communication terminal apparatus including: a communication unit configured to perform a predetermined communication; a storage unit configured to store a first state of an application program before being initialized and a second state of the application program after being initialized; an application management unit configured to activate based on the second state of the application program stored in the storage unit in preference to the first state of the application program stored in the storage unit. The application management unit causes the storage unit to store the second state of the application program if the communication unit performs the predetermined communication.

### BRIEF DESCRIPTION OF THE DRAWINGS

In the accompanying drawings:

FIG. 1 is an exemplary block diagram showing a configuration of a mobile communication terminal apparatus according to an embodiment of the present invention;

FIG. 2 is an exemplary view showing an exemplary structure of application management information according to the embodiment;

FIG. 3 is an exemplary flowchart showing operations, performed by an application management section according to the embodiment, for activating an application responsive to a notification of an occurrence of an event;

FIG. 4 is an exemplary flowchart showing operations, performed by an application management section according to the embodiment and including displaying an application list to activate an application;

FIG. 5 is an exemplary view showing one example of a display-order sorted application name list displayed on a display section by an application management section according to the embodiment; and

FIG. 6 is an exemplary flowchart showing operations, performed by an application management section according to the embodiment, for adding an application.

### DESCRIPTION OF THE EMBODIMENTS

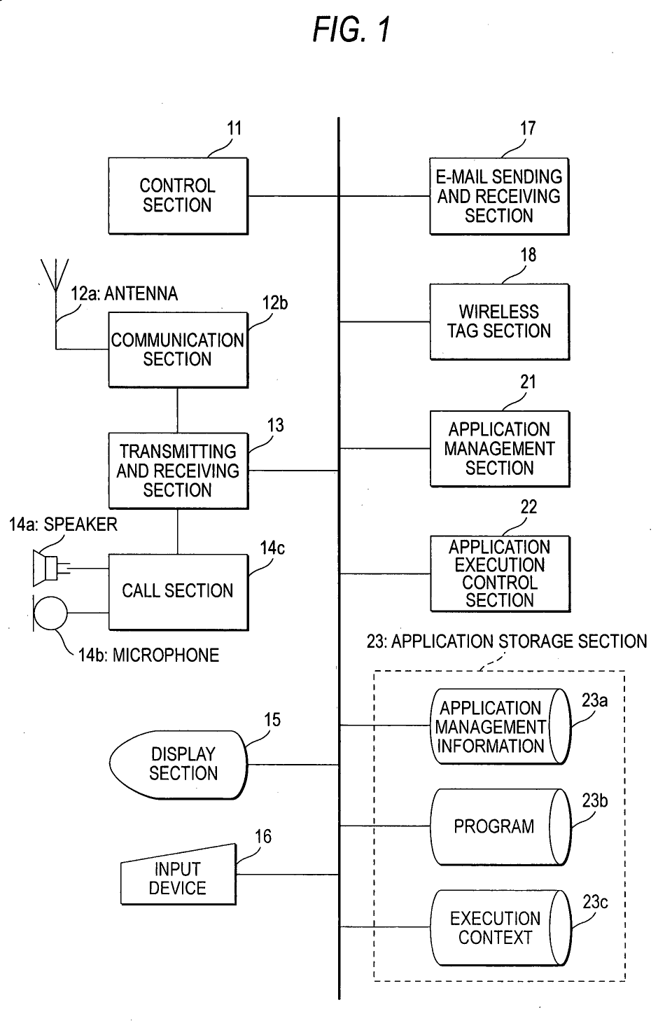

Referring to the drawings, hereinafter, a description is given of an embodiment of a mobile communication terminal apparatus according to the present invention. FIG. 1 is an exemplary block diagram showing a configuration of a mobile communication terminal apparatus according to an embodiment of the present invention. The mobile communication terminal apparatus includes: a control section 11 for controlling the entire apparatus; an antenna 12a for transmitting and receiving a radio wave to and from a base station (not shown) to perform communication therebetween via a mobile communications network; a communications section 12b; a transmitting and receiving section 13; a speaker 14a for call-receiving use; a microphone 14b for call-sending use; a call section 14c; a display section 15; an input device 16; an e-mail sending and receiving section 17; a wireless tag section 18 which performs communication with a reader/writer (not shown); an application management section 21; an application execution control section 22; and an application storage section 23.

As used herein, at least a part of the control section 11, the e-mail sending and receiving section 17, the application management section 21, and the application execution control section 22 are formed of a computer and a program used in the computer.

The application storage section 23 stores therein application management information 23a, a program 23b which is an application program in a non-initialized state, and an execution context 23c which is an application program in an initialized state. Hereinafter, a non-initialized application program is simply referred to as a program, and an initialized application program is referred to as an execution context.

These pieces of information stored in the application storage section 23 are managed by the application management section 21, and a program 23b and an execution context 23c are activated by the application execution control section 22.

Referring to FIG. 1, a description is made as to operations of each section of the mobile communication terminal apparatus according to the embodiment of the present invention.

The control section 11 controls each section of the apparatus, when a control signal is received at the transmitting and receiving section 13, when a predetermined key is manipulated on the input device 16, or when each section of the apparatus operates. Particularly, when an incoming call signal is received, the control section 11 notifies the application management section 21 of the occurrence of the event of reception, so as to activate an application stored in the application storage section 23 and corresponding to the occurrence of the event.

Further, the control section 11 may activate an application in a similar manner when, for example, an incoming e-mail signal other than an incoming call signal is received by the transmitting and receiving section 13. Further, there may be a case where the control section 11, when it receives a notification of an event from each section of the apparatus, notifies the application management section 21 of the occurrence of the thus received event, so as to activate an application stored in the application storage section 23.

The communications section 12b outputs to the transmitting and receiving section 13 a high-frequency signal received by the antenna 12a, or transmits via the antenna 12a a high-frequency signal outputted from the transmitting and receiving section 13.

The transmitting and receiving section 13 performs amplification, frequency conversion, and modulation on a high-frequency signal from the communications section 12b, so as to obtain a digital audio signal, an e-mail, and a control signal including an incoming call signal. The transmitting and receiving section 13 then transmits the digital audio signal to the call section 14c, the e-mail to the e-mail sending and receiving section 17, and the control signal to the control section 11. Further, the transmitting and receiving section 13 performs demodulation, frequency conversion, and amplification on a digital audio signal outputted from the call section 14c, an e-mail outputted from the e-mail sending and receiving section 17, and a control signal outputted from the control section 11 so as to obtain a high-frequency signal, and transmits it to the communications section 12b.

The call section 14c converts a digital audio signal outputted from the transmitting and receiving section 13 to an analog audio signal, and amplifies and transmits the signal to the speaker 14a for call-receiving use. Further, the call section 14c amplifies an analog audio signal outputted from the microphone 14b, converts the signal to a digital audio signal, and transmits it to the transmitting and receiving section 13.

The display section 15 is, for example, an LCD (Liquid Crystal Display) with a backlight. Under the control of the control section 11, the display section 11 causes the backlight to illuminate, and carries out display of text data, numeric data, and/or image data. The data being displayed is switched according to an instruction provided from the control section 11 in response to an input operation made on or an incoming call signal supplied from the input device 16.

The input device 16 is configured by keys including: alphabetic keys and numeric keys, which are used to designate a telephone number of a call recipient; and a plurality of function keys. When a key input operation is made on the input device 16, the input device 16 receives the key input operation and notifies the control section 11 of an identifier of the key. Then, display is carried out on the display section 15 in the form of text or an operation is performed by the control section 11 and the processing section that received the identifier via the control section 11.

The e-mail sending and receiving section 17 is a device that sends and receives e-mails. The e-mail sending and receiving section 17 does not use a specific protocol for sending and receiving an e-mail. E-mail transmission operation of the e-mail sending and receiving section 17 is activated by manipulation of a predetermined key on the input device 16, and the e-mail sending and receiving section 17 transmits the title and message body of an e-mail created by manipulation of a predetermined key on the input device 16 via the transmitting and receiving section 13.

Further, e-mail reception operation of the e-mail sending and receiving section 17 is activated by the control section 11 when an e-mail is received at the transmitting and receiving section 13 and the e-mail sending and receiving section 17 stores the thus received e-mail to a mailbox provided therein. Further, the e-mail sending and receiving section 17 carries out display operation of the received e-mail by manipulation of a predetermined key on the input device 16. In this way, the e-mail stored in the mail box is displayed on the display section 15.

Further, when the e-mail sending and receiving section 17 receives a predetermined e-mail, it notifies the application management section 21 via the control section 11 about an event of the reception, and activates an application stored in the application storage section 23 and corresponding to the occurrence of the event. As used herein, the predetermined e-mail may be an e-mail having a title and/or message body including predetermined information, or may be an e-mail sent from a predetermined e-mail address.

The wireless tag section 18 includes an IC chip and an antenna. The wireless tag section 18 is activated by receiving a radio wave transmitted from a reader/writer located at a short distance from the apparatus, and performs wireless communication with the reader/writer.

One purpose of the communication operation is to make a settlement of a purchase price. Specifically, a reader/writer is, for example, connected to and located near a register at a shop, receives a total sales price added up by the register with regard to commodities, and requests a wireless tag section 18 to pay the total price. The wireless tag section 18 then makes a settlement by subtracting the total price from the prepaid amount stored in the IC chip, and terminates the communication operation.

Another example of the settlement is payment by a credit card. Specifically, a wireless tag section 18 communicates with a reader/writer to make a payment using a credit card, notifies an application management section 21 via a control section 11 about an event indicating the communication has been performed for the payment together with a predetermined parameter, and activates an application program stored in an application storage section 23 and corresponding to the occurrence of the event.

Another purpose of the communication operation relates to checking of a ticket. Specifically, a reader/writer is, for example, connected to a ticketing device provided in a railway station and is located at a ticket gate. When a person goes in through the ticket gate, the reader/writer receives from the ticketing device a name of the station where the ticketing device is provided and a base fare. The reader/writer then requests a wireless tag section 18 to store the station's name and pay the fare. Further, the wireless tag section 16 stores the station's name into an IC chip, makes a settlement of the fare by subtracting the fare from the prepaid amount stored in the IC chip, and terminates the communication operation.

Meanwhile, when a person goes out through a ticket gate, a reader/writer requests the wireless tag section 18 to transmit the stored name of the station, where the person entered. The wireless tag section 18 then transmits the station's name stored in the IC chip. Subsequently, the reader/writer finds a fare between the station identified based on the thus received station's name and a station where the ticketing device is provided. Further, the reader/writer calculates an unpaid fare by subtracting the base fare, which has been paid at the entrance station, from the thus found fare and requests the wireless tag section 18 to pay the unpaid fare. The wireless tag section 18 then makes a settlement by subtracting the unpaid fare from the prepaid amount stored in the IC chip, and terminates the communication operation.

Another example of checking of a ticket is, for example, admission to a theater. Specifically, a reader/writer is provided at an entrance gate of a theater, and when a person goes in through the entrance gate, the reader/writer requests a wireless tag section 18 to delete information indicating permission to enter the theater. The wireless tag section 18 then makes a payment for the admission by deleting the information indicating the entrance permission that is stored in an IC chip, and terminates the communication operation.

Another example of checking a ticket relates to entrance management for a specific person having entrance permission. Specifically, a reader/writer is provided at an entrance of, for example, a room where confidential information is stored. When a person goes in through the entrance, the reader/writer requests a wireless tag section 18 to transmit identification information of a device. The wireless tag section 18 then transmits the information, and the reader/writer receives the thus transmitted information. When the reader/writer has stored information that a user of a device storing the information has entrance permission, the wireless tag section 18 terminates the communication operation and unlocks the door of the room.

In these cases regarding checking of a ticket, the wireless tag section 18 notifies an application management section 21 via a control section 11 about an event indicating that the communication has been performed for checking a ticket at a station, for admission to a theater, or for entrance management, together with a predetermined parameter. The wireless tag section 18 then activates an application program stored in an application storage section 23 and corresponding to each occurrence of an event.

The application management section 21 manages application programs stored in the application storage section 23. Specifically, the application management section 21 newly stores, updates, or deletes an application program in the application storage section 23. Further, with regard to a part of or all of the applications, the application management section 21 controls the application execution control section 22 to create an execution context 23c of each application in addition to or instead of a program 23b, and to store the thus created execution context 23c into the application storage section 23. Further, the application management section 21 instructs the application execution control section 22 to execute a program 23b or an execution context 23c, based on an instruction provided from each section of the apparatus.

The application execution control section 22 activates a program 23b or an execution context 23c based on an instruction provided from the application management section 21, and thereby activates and executes an application. After activation of the execution context 23c, the application execution control section 22 immediately causes the execution context 23c to operate.

Furthermore, upon activation of the program 23b, the application execution control section 22 initializes the program 23b and causes it to operate continuously. Also, based on an instruction from the application management section 21, the application execution control section 22 stores the initialized program 23b into the application storage section 23 as an execution context 23c. Note that, when the program 23b is written in JAVA®, the application execution control section 22 is called a JAVA virtual machine.

When the program 23b is written in a procedural language, before the program reaches an initialized state, the application execution control section 22 performs operations that have not been executed, from among operations such as compiling, linking, and assigning an initial value. When the program 23b is written in JAVA®, the application execution control section 22 performs operations such as creating an object using a static function before the program reaches an initialized state.

Hereinafter, a description is given of operations related to a high-speed processing for activating an application in a mobile communication terminal apparatus of the embodiment.

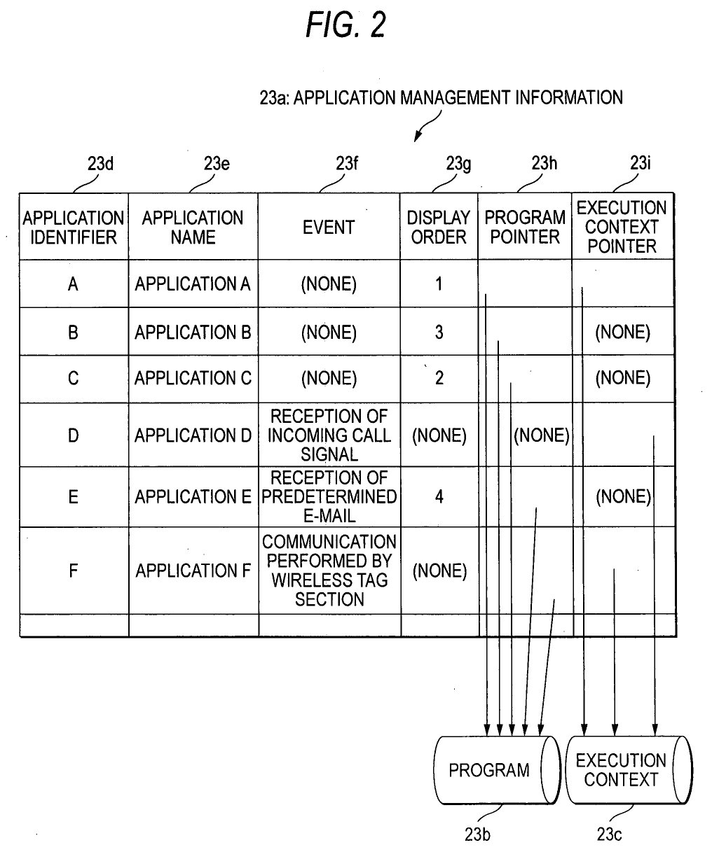

FIG. 2 shows an exemplary structure of the application management information 23a. The application management information 23a includes pieces of information such as application identifier 23d, application name 23e, event 23f, display order 23g, program pointer 23h, and execution context pointer 23i, which are associated with one another.

The application identifier 23d is an identifier for uniquely identifying each set of the associated pieces of information. Further, the application identifier 23d is defined appropriately every time each set of the associated pieces of information is newly stored. The application name 23e is the name of an application.

The event 23f indicates that, when it occurs, an application identified by an application identifier 23d is activated. When the event 23f is not stored, the application is not activated due to the occurrence of an event. The example shown in FIG. 2 indicates that applications identified by application identifiers 23d “A,” “B,” and “C” are not activated due to the occurrence of events.

Further, applications identified by application identifiers 23d “D,” “E,” and “F” are respectively activated when an incoming call signal is received, when a predetermined e-mail is received, and when the wireless tag section 18 performs communication.

The application that is activated when an incoming call signal is received (application having an application identifier 23d “D”) is an application for annunciating an incoming call. The annunciation is made by displaying a moving image on the display section 15, issuing a ring alert from a speaker for application-use (not shown), or the like.

The application that is activated when a predetermined e-mail is received (application having an application identifier 23d “E”) is an application for annunciating, for example, reception of an e-mail as an emergency notification. The annunciation is made by displaying a moving image on the display section 15, or issuing a ring alert from a speaker for application-use (not shown), or the like.

The application that is activated when the wireless tag section 18 performs communication (application having an application identifier 23d “F”) is provided with pieces of information as parameters, for example, the fact that the communication is performed for payment using a credit card, a credit card number stored in the wireless tag section 18, and the amount of the payment. The payment, i.e., an amount of money integrated according to the credit card number, is sent via the transmitting and receiving section 13 to a credit card integration management device (not shown), so that the settlement operation is made.

Further, the application that is activated when the wireless tag section 18 performs communication is provided with pieces of information as parameters, for example, the fact the communication is performed for checking a ticket at a station, and the name of the station. Further, the e-mail sending and receiving section 17 is instructed to send an e-mail for obtaining information about the station and trains leaving and arriving at the station to a predetermined address. Further, instead of sending an e-mail, a browser section (not shown) may be instructed to access a predetermined Web address so that the obtained information may be displayed on the display section 15.

Further, the application that is activated when the wireless tag section 18 performs communication is provided with pieces of information as parameters, for example, the fact that the communication is performed for checking a ticket at a theater, and the name of the theater. Operations for obtaining information about the theater are performed, as in the communication performed for checking a ticket at a station.

The display order 23g indicates the position of each application name 23e in a list displayed on the display section 15. The lower the display order 23g an application has, the closer to the top its application name 23e is displayed. When a display order 23g is not stored, an application name 23e associated with the display order 23g is not displayed on the display section 15.

The example shown in FIG. 2 shows that applications having application identifiers 23d “A,” “B,” “C,” and “E” respectively have display orders 23g “1,” “3,” “2,” and “4” and that their application names 23e are displayed from top to bottom in this order. As for applications having application identifiers 23d “D” and “F,” their application names 23e are not displayed on the display section 15.

Note that, as will be described later, when one of the application names 23e displayed in the list is selected by manipulation of a predetermined key on the input device 16, the selected application is activated.

The program pointer 23h is a pointer that indicates a program 23b of an application identified by an application identifier 23d and not having undergone initialization. Further, the execution context pointer 23i is a pointer that indicates an execution context 23c of the application having undergone initialization. When no value is stored in these pointers, a program 23b or execution context 23c indicated by each pointer has not been stored. Further, a value is stored in, at least, one of these pointers.

The application management information 23a is partially or fully stored in manufacturing of the apparatus. Further, the application management information 23a is partially or fully stored, updated, or deleted according to manipulation of a predetermined key on the input device 16.

Hereinafter, a detailed description is given of operations of the application management section 21.

[Operations for Activating an Application According to the Occurrence of an Event]

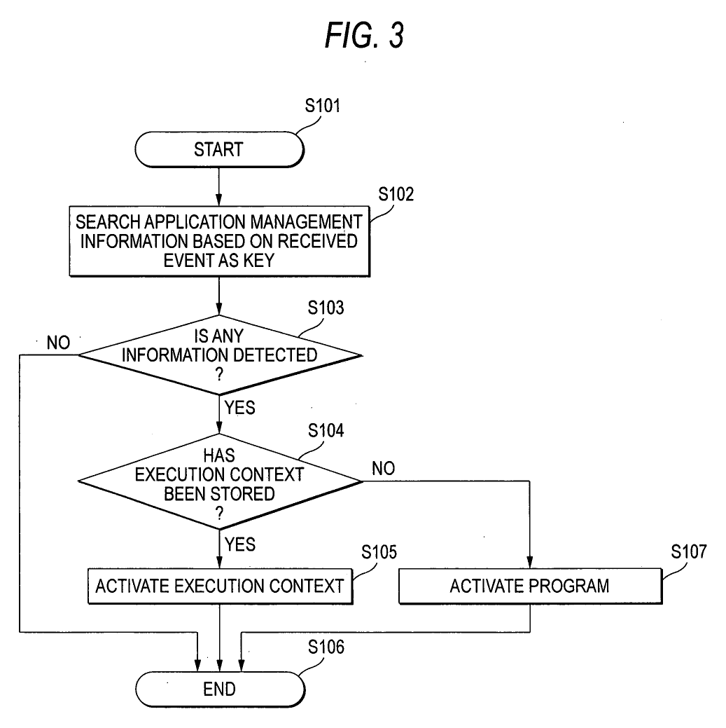

FIG. 3 is an exemplary flowchart showing operations of the application management section 21 to activate an application upon reception of a notification of the occurrence of an event. The application management section 21 starts operations when it receives a notification from the control section 11 about the occurrence of an event (Step S101) and then searches application management information 23a based on the search criteria that the received event is equal to an event 23f (Step S102).

The application management section 21 checks whether there is detected any application management information 23a that satisfies the criteria (Step S103). When it is detected, the application management section 21 checks whether an execution context pointer 23i of the application management information 23a is stored (Step S104). If it is stored, the application management section 21 instructs the application execution control section 22 to activate an execution context 23c indicated by the execution context pointer 23i (Step S105), and terminates the operation (Step S106).

If it is not stored in Step S104, the application management section 21 instructs the application execution control section 22 to activate a program 23b indicated by a program pointer 23h of the thus detected application management information 23a (Step S107), and terminates the operation (Step S106).

In Step S103, if there is detected no application management information 23a that satisfies the search criteria, the application management section 21 terminates the operation (Step S106). With the above operations, the application management section 21 causes the execution control section 22 to activate an execution context 23c in preference to a program 23b, thereby realizing fast activation.

[Operations Including Displaying an Application List to Activate an Application]

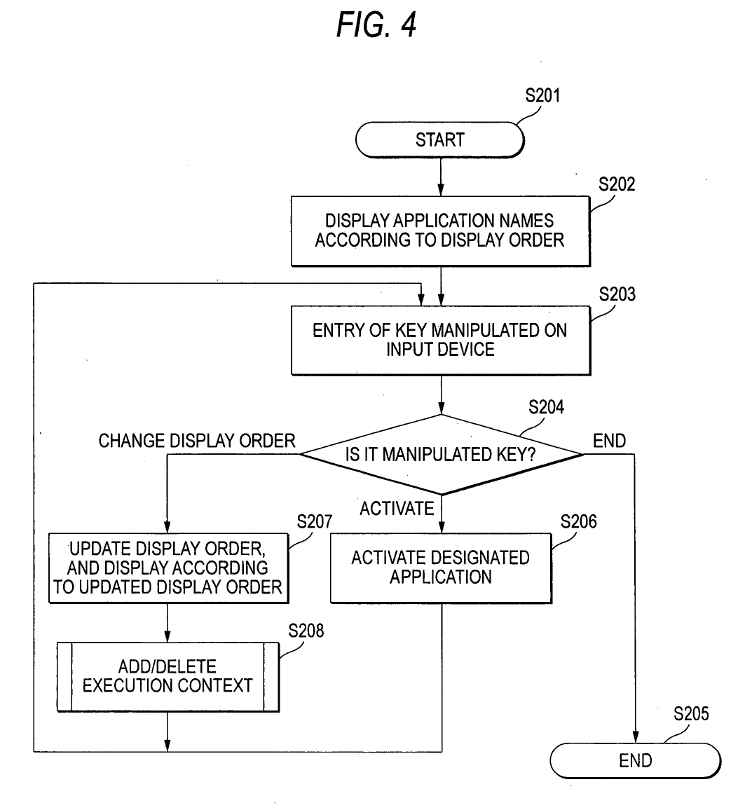

FIG. 4 is an exemplary flowchart showing operations of the application management section 21, such as displaying an application list to activate an application. The application management section 21 is activated by the control section 11 to start operations, according to manipulation of a predetermined key on the input device 16 (Step S201) and carries out display of a list of application names 23e stored in the application management information 23a on the display section 15 (Step S202).

When carrying out the display, the application management section 21 displays only application names 23e that are associated with display orders 23g each storing an order. Here, the smaller the number the display order 23g stores, that is, in the case of a horizontal display, the smaller the number stored, the closer to the top the application name 23e is displayed.

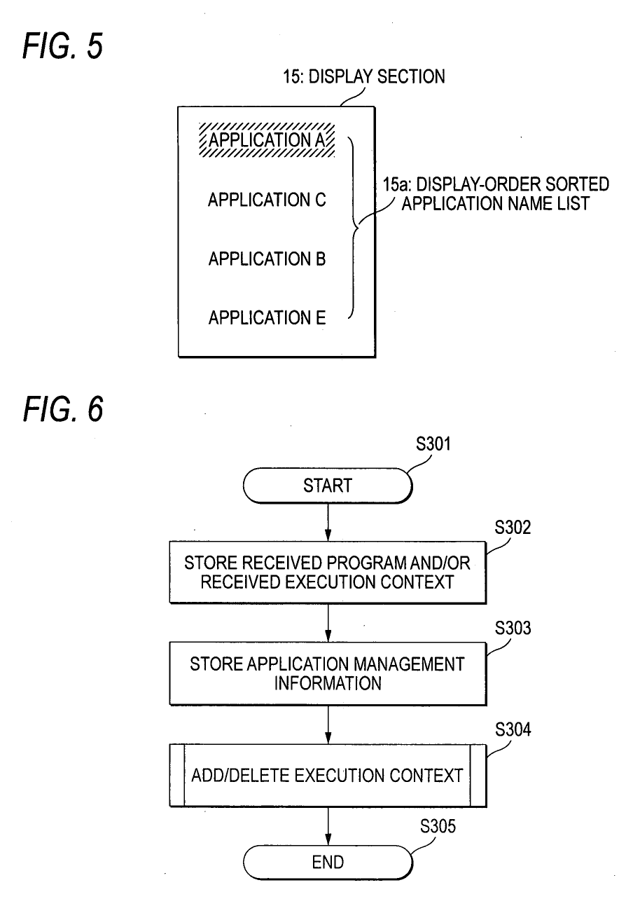

FIG. 5 exemplary shows one example of a display-order sorted application name list 15a displayed on the display section 15. This display-order sorted application name list 15a corresponds to the application management information 23a shown in FIG. 2. Thus, the lower the number a display orders 23g stores from among 1 through 4, the closer to the top its associated application name 23e is displayed.

Then, a cursor is placed on one of the thus displayed application names 23e. The application name 23e where the cursor is placed is indicated in, for example, a different color distinctive from the others. In FIG. 5, the placement of the cursor is indicated by hatching.

Note that, in the initial state in which the display-order sorted application name list 15a is first displayed, the cursor is placed on the top one, i.e., on an application name 23e associated with a display order 23g with the lowest number. Thus, as will be described below, an application having a display order 23g with the lowest number requires the least operation for activation. It may be therefore considered that an application having a display order 23g with the lowest number is activated by the user most frequently.

Next, the application management section 21 receives from the control section 11 information for identifying a key manipulated on the input device 16 (Step S203). Further, the operations are branched according to the manipulated key (Step S204). When the key is the one for moving the cursor, for example, an up arrow key or a down arrow key, the application management section 21 moves the cursor to an application name 23e positioned one above or one below (not shown). Meanwhile, when the key is the one for instructing termination of the operation, the application management section 21 terminates the operation (Step S205).

Further, when the key is the one for instructing activation of the application name 23e, the application management section 21 instructs the application execution control section 22 to activate an execution context 23c indicated by an execution context pointer 23i, or a program 23b indicated by a program pointer 23h, which are associated with the application name 23e where the cursor is placed (Step S206) and then returns to the operation for receiving information for identifying a key manipulated on the input device 16 in Step S203. Note that, operations for activating either an execution context 23c or a program 23b are the same as those described in the operation for activating an application according to the occurrence of an event.

Furthermore, in Step S204, when the manipulated key is the one for instructing to make a change in the display order of the application names 23e, i.e., a change in the display orders 23g, in the display-order sorted application name list 15a, the application management section 21 updates and stores the display orders 23g according to the key manipulation, and makes a change in the display-order sorted application name list 15a that appeared on the display section 15 according to the updated display orders 23g (Step S207).

Further, the application management section 21 performs an operation for adding/deleting an execution context 23c (Step S208), and returns to the operation for receiving information for identifying a key manipulate don the input device 16. Note that, the operation for adding/deleting an execution context 23c in Step S208 will be described later.

In the foregoing description, the application management section 21 displays only application names 23e that are associated with display orders 23g each storing an order. However, the embodiment is not limited to this. Application names 23e that are associated with display orders 23g storing no order may also be displayed so as to clarify that no order is stored, and in Step S207, an instruction may be provided as to whether or not a display order 23g stores an order.

Further, the process for a display order 23g that stores no order may be provided as an optional function. As to whether or not to perform this process, selection may be made by manipulation of a predetermined key on the input device 16.

Further, in the foregoing description, the application management section 21 does not display an event 23f on the display section 15. However, the embodiment is not limited to this and may be arranged such that an event 23f is displayed on the display section 15, an instruction for updating the display is entered, the content displayed on the display section 15 is updated according to the entered instruction, and further the event 23f is updated and stored. Further, the process for this event 23f may be provided as an optional function. As to whether or not to perform this process, selection may be made by manipulation of a predetermined key on the input device 16.

Further, besides the above-described operations, the application management section 21 may perform any one of the following deletion operations according to manipulation of a predetermined key on the input device 16; deletion of information identified by an application name 23e where the cursor is placed, i.e., deletion of application management information 23a; deletion of a program 23b; and deletion of an execution context 23c.

As a matter of course, deletion of application management information 23a involves deletion of a program 23b indicated by a program pointer 23h and deletion of an execution context 23c indicated by an execution context pointer 23i. Further, as a matter of course, deletion of a program 23b involves deletion of a program pointer 23h, and deletion of an execution context 23c involves deletion of an execution context pointer 23i.

[Operations for Adding an Application]

FIG. 6 is an exemplary flowchart showing operations of the application management section 21 to receive an application and store it in application management information 23a. For example, the application management section 21 is activated by the control section 11 to start operations when an application is received by the transmitting and receiving section 13 (Step S301).

Further, the application management section 21 stores the received program and/or received execution context program in the application storage section 23 (Step S302). Specifically, when a non-initialized program is received, the application management section 21 stores the program as a program 23b or when an initialized execution context is received, the application management section 21 stores the execution context as an execution context 23c, in the application storage section 23.

Next, the application management section 21 stores information relating to the thus received application in the application storage section 23 (Step S303). Specifically, a received application name is set to the application name 23e and a received event is set to the event 23f. Further, when a non-initialized program is received, a pointer indicating the program 23b is set to the program pointer 23h, and when an initialized execution context is received, a pointer indicating the execution context 23c is set to the execution context pointer 23i. In this way, the information is stored in the application management information 23a. Herein, to the display order 23g, a number greater than the number being stored in the stored display order 23g is set and stored as an implicit value.

Further, the application management section 21 performs an operation for adding/deleting an execution context 23c (Step S304), and terminates the operation (Step S305). Note that, the operation for adding/deleting an execution context 23c in Step S304 will be described later.

In the foregoing description, an application is received via the transmitting and receiving section 13. However, the embodiment is not limited to this. For example, the apparatus may include a connector section (not shown) to which a detachable external storage medium is connected, so as to receive an application stored in the external storage medium via the connector section.

[Operations for Adding/Deleting an Execution Context 23c]

A description is given of operations of the application management section 21 for adding/deleting an execution context 23c. As described above, when activating an application indicated by an application identifier 23d, the application execution control section 22 can activate the application by either a program 23b or execution context 23c of the application.

It should be noted that, if an execution context 23c has been stored, the activation time can be shortened. On the other hand, an execution context 23c normally requires a larger storage capacity compared to a program 23b. Thus, it is appropriate to store an execution context 23c that corresponds to an application in great need.

As described above, storing an execution context 23c in the application section 23 becomes possible by providing instructions to the application execution control section 22. However, the arrangement is not limited to this. For example, an execution context 23c may be stored in an external storage section (not shown) that requires more access time compared to the application storage section 23, so that the execution context 23 can be copied to the application storage section 23. Further, an execution context 23c may be stored in a server device (not shown), so that it can be copied to the application storage section 23.

For the above purpose, the application management section 21 creates or deletes an execution context 23c of each application, based on one criterion or combination of criteria specified below. As a matter of course, when creating it, the application management section 21 stores a pointer indicating the created execution context 23c to the execution context pointer 23i, and, when deleting it, deletes the pointer from the execution context pointer 23i.

One example of the criteria is that an execution context 23c is created for an application having a display order 23g with a low number, i.e., application appearing closer to the top when displayed on the display section 15. This is because an application appearing closer to the top is considered to be used more frequently by a user of the apparatus. Conversely, for an application associated with a display order 23g with a higher number, its execution context 23c is deleted.

Another example of the criteria is that an execution context 23c is created for an application that takes time for initialization, i.e., an application that requires a longer time to create an execution context 23c. This is because, if an execution context 23c has been stored, the activation time is significantly shortened, which brings greater effect on an application that takes a longer time for initialization. Conversely, for an application that needs only a short time to create an execution context 23c, its execution context 23c is deleted.

The application management section 21 may compare a time taken for initialization to a predetermined value, so as to judge whether to create an execution context 23c based on whether the time is more or less than the predetermined value. The initialization time of each application may be stored in application management information 23a and the times corresponding to each application may be compared to make the judgement.

Note that, the initialization time can be measured by causing the application execution control section 22 to activate an application from a program 23b. In this case, the application management section 21, after it causes the application execution control section 22 to activate an application in Step S206, receives a notification of the initialization time, and adds and/or deletes an execution context 23c depending on the thus notified time.

Note that, when an execution context 23c is stored in an external storage section or a server device, the initialization time is assumed as a time required for copying the stored execution context 23c to the application storage section 23.

Another criterion is that an execution context 23c is created for an application that has an event 23f storing information, in particular, for an application that stores information relating to a communication function. This is because, for an application that is activated upon occurrence of an event 23f relating to communication functions, fast activation enables the communication function to operate efficiently. Conversely, an execution context 23c for an application having an event 23f that stores no information relating to a communication function, in particular, for an application that has an event 23f storing no information is deleted.

In the application management information 23a shown in FIG. 2, as for an application corresponding to an event 23f indicating “reception of incoming call signal,” fast activation enables a user of the apparatus to be notified immediately about the reception of the incoming call signal, allowing the user to start to make a call immediately. This brings increased convenience to the user and benefits in efficiently using a mobile communications network in which a large number of mobile communication terminal apparatuses are connected.

FIG. 2 shows an example that a program 23b corresponding to the event 23f is not stored but an execution context 23c is stored. When a program 23b is not stored, a corresponding execution context 23c is never deleted.

As for an application corresponding to an event 23f indicating “communication of wireless tag section,” fast activation enables communication to be immediately started via the transmitting and receiving section 13, allowing the operation to be terminated quickly. This brings increased convenience to the user and benefits in efficiently using, for example, a reader/writer.

Further, as for an application corresponding to an event 23f indicating “reception of predetermined e-mail,” fast activation enables a user of the apparatus to be notified immediately about the reception of the e-mail, thereby providing increased convenience. However, the following communication operation subsequent to the reception of the e-mail, for example, whether to send a response e-mail message, varies depending on the situation. Thus, fast activation is not so important for an application corresponding to this event 23f, when compared to applications corresponding to the above two events 23f. Therefore, FIG. 2 shows an example that no execution context 23c corresponding to this event 23f is stored.

Another criterion is the size of an unused storage capacity of the application storage section 2, which is available for an execution context 23c. This criterion is a trade-off with the criterion for creating an execution context 23c. When the storage capacity is large, an execution context 23c is created for all the applications that are preferably judged to have execution context 23c. On the other hand, when the storage capacity is small, an execution context 23c is created only for those critically selected from among applications that are preferably judged to have execution context 23c.

Further another criterion is that an execution context 23c is created or deleted according to manipulation of a predetermined key on the input device 16. Further, number of times each application program has been activated is stored in the application management information 23a, so that an execution context 23c is created for those having application programs that have been activated many times. Conversely, an execution context 23c is deleted for those having application programs that have been activated few times.

In the foregoing description, a program 23b is a non-initialized application program. However, a program 23b is not necessarily an application program and may be just data, for example, a source program written in a procedural language. In this case, the program may be required to be compiled before being activated.

In the foregoing description, a program 23b and an execution context 23c are executable application programs. However, this does not necessarily mean that a program 23b and an execution context 23c include executable mechanical instructions. In a case where an application program is written in an interpreter language, a program 23b and an execution context 23c are not application programs formed of computer-executable mechanical instructions, but those implemented by the operations of the application executable control section 22.

Further, a program 23b and an execution context 23c may be compressed and decompressed to be executable. Further, a program 23b and an executable context 23c may be, but not limited to, a file format. The embodiment is not limited to the above described configurations, and various modifications may be made.

According to the above-described embodiment, a mobile communication terminal apparatus can stores an initialized state of an application program activated in high-speed.

What is claimed is:

1. A mobile communication terminal apparatus comprising:
a communication unit configured to perform a predetermined communication;
a storage unit configured to store a first state of an application program before being initialized and a second state of the application program after being initialized;
an application management unit configured to activate based on the second state of the application program stored in the storage unit in preference to the first state of the application program stored in the storage unit;
wherein the application management unit causes the storage unit to store the second state of the application program if the communication unit performs the predetermined communication.

2. A mobile communication terminal apparatus comprising:
a communication unit configured to perform a predetermined communication;
a storage unit configured to store a first state of an application program before being initialized and a second state of the application program after being initialized; and
an application management unit configured to activate the second state if the second state of the application program is stored in the storage unit and activate the first state of the application program if the second state of the application program is not stored in the storage unit,
wherein the application management unit causes the storage unit to store the second state of the application program when the communication unit performs the predetermined communication.

3. The mobile communication terminal apparatus of claim 1, wherein the communication unit performs communication via a mobile communications network, and
wherein the predetermined communication is that the communication unit receives a predetermined incoming signal via the mobile communications network.

4. The mobile communication terminal apparatus of claim 2, wherein the communication unit performs communication via a mobile communications network, and
wherein the predetermined communication is that the communication unit receives a predetermined incoming signal via the mobile communications network.

5. The mobile communication terminal apparatus of claim 1, wherein the communication unit performs communication via a mobile communications network, and
wherein the predetermined communication is that the communication unit receives a predetermined e-mail is received via the mobile communications network.

6. The mobile communication terminal apparatus of claim 2, wherein the communication unit performs communication via a mobile communications network, and
wherein the predetermined communication is that the communication unit receives a predetermined e-mail via the mobile communications network.

7. The mobile communication terminal apparatus of claim 1, wherein the communication unit is a wireless tag, and
wherein the predetermined communication is performed by the wireless tag with a reader/writer.

8. The mobile communication terminal apparatus of claim 2, wherein the communication unit is a wireless tag, and
wherein the predetermined communication is performed by the wireless tag with a reader/writer.

9. A mobile communication terminal apparatus comprising:
a display unit;
an input unit;
a storage unit configured to store a priority to display the application program and either one of a first state of an application program before being initialized and a second state of the application program after being initialized; and
an application management unit configured to cause the display unit to display, in descending order, an information for identifying the application program stored in the storage unit, the application management unit configured to activate, in preference to the first state of the application program, the second state of the application program which is identified by the information and stored in the storage unit if the information is selected based on an operation of the input unit, wherein the application management unit causes the storage unit to store the second state of the application program with a high display order.

10. A mobile communication terminal apparatus comprising:
a display unit;
an input unit;
a storage unit configured to store a priority to display the application program and either one of a first state of an application program before being initialized and a second state of the application program after being initialized; and
an application management unit configured to cause the display unit to display, in descending order, an information for identifying the application program stored in the storage unit, the application management unit configured to activate the second state of the application program in case that the second state of the application program is stored in the storage unit, if an information for identifying the application program stored in the storage unit is selected based on an operation of the input unit, the application management unit configured to activate the first state of the application program in case that the second state of the application program is not stored in the storage unit, wherein the application management unit causes the storage unit to store the second state of the application program with a high display order.

11. The mobile communication terminal apparatus according to claim 1, wherein the application management unit causes the storage unit to store the second state of the application program to take a long time until the second state of the application program is obtained, in preference to the second state of the application program to take a short time until the second state of the application program is obtained.

12. The mobile communication terminal apparatus according to claim 2, wherein the application management unit causes the storage unit to store the second state of the application program to take a longtime until the second state of the application program is obtained, in preference to the second state of the application program to take a short time until the second state of the application program is obtained.

13. The mobile communication terminal apparatus according to claim 9, wherein the application management unit causes the storage unit to store the second state of the application program to take a long time until the second state of the application program is obtained, in preference to the second state of the application program to take a short time until the second state of the application program is obtained.

14. The mobile communication terminal apparatus according to claim 10, wherein the application management unit causes the storage unit to store the second state of the application program to take a long time until the second state of the application program is obtained, in preference to the second state of the application program to take a short time until the second state of the application program is obtained.

15. The mobile communication terminal apparatus according to claim 1, wherein an initializing operation includes at least one operation of compiling, linking, assigning an initial value, and creating an object using a static function.

16. The mobile communication terminal apparatus according to claim 2, wherein an initializing operation includes at least one operation of compiling, linking, assigning an initial value, and creating an object using a static function.

17. The mobile communication terminal apparatus according to claim 9, wherein an initializing operation includes at least one operation of compiling, linking, assigning an initial value, and creating an object using a static function.

18. The mobile communication terminal apparatus according to claim 10, wherein an initializing operation includes at least one operation of compiling, linking, assigning an initial value, and creating an object using a static function.
